(19) United States
(12) Patent Application Publication
(10) Pub. No.: US 2012/0203648 A1
(43) Pub. Date: Aug. 9, 2012

(54) LENDING DIGITAL MEDIA CONTENT

(75) Inventor: Leigh M. Rothschild, Sunny Isles Beach, FL (US)

(73) Assignee: REAGAN INVENTIONS LLC, Sunny Isles Beach, FL (US)

(21) Appl. No.: 13/445,395

(22) Filed: Apr. 12, 2012

Related U.S. Application Data
(63) Continuation-in-part of application No. 12/151,165, filed on May 5, 2008.

(51) Int. Cl. G06F 21/00; G06Q 30/06; G06F 15/16

(52) U.S. Cl. 705/26.1; 726/28

(57) ABSTRACT

A system and method are provided for lending digital media content. A system, according to one implementation, comprises a mobile device having a user interface configured to output at least one of audio signals and video signals to a user of the mobile device. The system also includes a server configured to store digital media content. The server configured to download the digital media content upon request. In addition, the system comprises a content lending management system associated with an establishment, where the establishment has a physical presence for meeting customers face-to-face. The content lending management system is configured to communicate with the mobile device and server. The content lending management system is further configured to receive a loan request from the mobile device and, in response to the loan request, provide the digital media content to the mobile device for temporary use.

### PRIORITY

This application is a continuation-in-part application of U.S. Ser. No. 12/151,165, filed May 5, 2008, entitled “SYSTEM AND METHOD FOR PREVIEWING AND PURCHASING DIGITAL CONTENT WITH A MOBILE DIGITAL STORAGE AND PLAYBACK DEVICE”, the contents of which are hereby incorporated by reference in its entirety.

### BACKGROUND

1. Field

The present disclosure relates generally to digital media content, and more particularly, to temporarily sharing digital media content with a mobile device.

2. Description of the Related Art

Portable digital devices are now common. Examples include the various Windows™ Pocket PC devices which have an operating system created by Microsoft Corporation of Redmond, Wash. Other devices include various mobile phone devices including many that have built-in camera imaging devices. Still other portable digital devices include portable media players from Creative Media of Singapore, Samsung of South Korea, Archos, Inc. of Irvine, Calif. and Apple Computers, Inc. of Cupertino, Calif. Additionally, Sony of New York and Japan manufacture a portable game playing device called the Sony PSP™ (PlayStation Portable).

Increasingly, many of these portable media devices are configured to transmit and receive digital content. Various communications technologies are frequently built into these devices. Examples of portable communicating devices include mobile phones which employ GSM, CDMA, W-CDMA, and FOMA technology, among other standards, to send and receive data in addition to handling voice communications. Many of the portable media devices also include transmission capabilities including Wi-Fi (IEEE 802.11a, b, g and x among others), Bluetooth™, infrared, etc., to allow the user to transmit and receive digital content. The Sony PSP™ device, for example, includes Wi-Fi (i.e., IEEE 802.11b) to transmit and receive digital data.

### SUMMARY

A system and method are provided for lending digital media content. According to one implementation, a system for lending digital media content comprises a mobile device having a user interface configured to output at least one of audio signals and video signals to a user of the mobile device. The system also includes a server configured to store digital media content, the server configured to download the digital media content upon request. The system also includes a content lending management system associated with an establishment, which has a physical presence for meeting customers face-to-face. The content lending management system is configured to communicate with the mobile device and server. The content lending management system is further configured to receive a loan request from the mobile device and, in response to the loan request, provide the digital media content to the mobile device for temporary use.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1A is front view of a mobile device according to an embodiment of the present disclosure;

FIG. 1B is a rear view of the mobile device of FIG. 1A;

FIG. 2 is a block diagram of various modules included in the mobile device illustrated in FIG. 1;

FIG. 3 illustrates a system for enabling remote communication between devices via a communication network; and

FIG. 4 is a block diagram illustrating a content lending management system, according to several embodiments of the present disclosure.

FIG. 5 is a block diagram illustrating a content lending program, according to several embodiments of the present disclosure.

FIG. 6 is a flow diagram illustrating a method performed by systems of an owner of digital media content, according to various embodiments.

FIGS. 7-11 are flow diagrams illustrating methods performed by systems of an establishment, according to various embodiments.

### DETAILED DESCRIPTION

Embodiments of the present disclosure will be described hereinbelow with reference to the accompanying drawings. In the following description, well-known functions or constructions may not be described in great depth, in order to avoid obscuring the present disclosure in unnecessary detail.

A system and method for lending digital content to a user of a mobile device provided. The present disclosure provides for lending digital content to a user of a mobile device when the user is within the confines of a particular location or establishment such as a book store, coffee shop, retail environment, etc. As a user enter the establishment, a node or server located in the establishment detects the presence of the mobile device of the user. Upon detection of the mobile device, the node or server determines if the user is a registered user, and if so, provides access to the mobile device of digital content available in the server. The selections of digital content may be suggested or pushed to the mobile device. Alternatively, the user of the mobile device may request certain selections of digital content. It is to be appreciated that the digital content will only be available to the mobile device while within the confines of the establishment. To use or access the digital content outside the confines of the establishment, the user may purchase the digital content via their mobile device.

In the entertainment business, any number of people may have a financial interest in various artistic works. For example, a musician who writes or records a song may receive a certain percentage for each time the song is sold to a customer or played on a radio station. Also, a distributing company responsible for distributing the song may also receive compensation based on sales. According to the embodiments of the present disclosure, systems and methods for distributing digital media content (e.g., music, videos, movies, books in electronic form, etc.) are provided.

The process of distributing digital media content, as particularly disclosed herein, includes setting up an arrangement between an owner of the digital media content (e.g., a copyright owner, artist, record label, media distributing company, etc.) and several establishments (e.g., coffee shops, shopping malls, doctor's offices, restaurants, or other physical facilities where potential customers may physically be present). The arrangement would allow the establishment to download the digital media content (perhaps at no charge or for a small charge) and temporarily lend the digital media content to potential customers who are currently within the establishment. Once the potential customer leaves the premises of the establishment, the digital media content would no longer be available.

This arrangement allows the owner to advertise, in a sense, a sample or portion of the digital work to potential customers in the hope that they will eventually want to purchase the work. Once a customer purchases the digital media content, the content is downloaded to the customer's mobile device and the customer may play the purchased content whenever he or she desires. On the other hand, some people may simply wish to try the media content but may then decide not to purchase it. In this respect, they may still enjoy the content only while on the premises of the establishment.

The processes described herein may also be beneficial to the owners of the various establishments. For example, if the establishment is a coffee shop, a customer who wishes to temporarily download an electronic book while at the coffee shop may spend a considerable amount of time there, which may result in more business (e.g., more sales of coffee) from the customer. Also, customers may discover the advantages of getting the opportunity to sample different digital media content in certain establishments, such as their favorite coffee shops for example, and frequent these establishments more often.

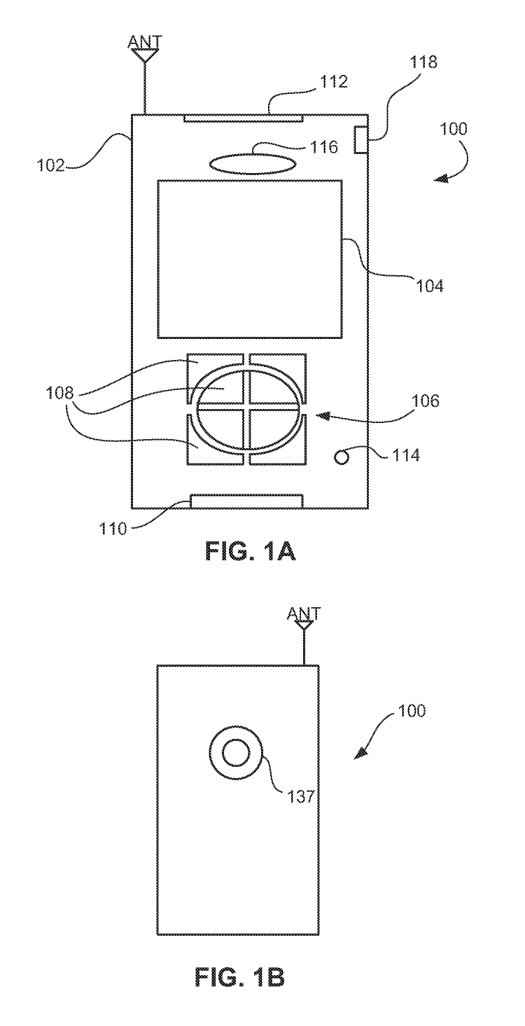

Referring to FIG. 1A, a mobile device 100, such as a portable media playback device or other portable digital device for receiving and playing various types of digital media content, e.g., audio, video, images, games, text, multimedia content, etc., in accordance with an embodiment of the present disclosure, is illustrated. The mobile device 100 may be a cellular phone, smart phone, laptop computer, tablet, electronic reading device, personal digital assistant (PDA), portable media player, or other portable electronic device.

The mobile device 100 includes various electrical components, which will be described in detail below, disposed in a generally rectangular housing 102. A display module 104 is provided for displaying video and image media content, such as movies, animations, etc., and a speaker 116 is provided configured to produce audio, e.g., music or a soundtrack associated with a video. An audio port 118 may be configured to receive a plug or connector from a headphone, stereo system, etc., to stream the audio to the connected device. It is to be appreciated that when an external device is connected to the audio port 118 the speaker 116 will be disabled. Input module 106 includes a plurality of buttons 108 for inputting data and navigating through a plurality of menus. A touch screen overlaid upon the display module 104 may also be coupled to the input module for facilitating user input. The mobile device 100 further includes a storage module 110 for storing a plurality of content and a transmission module 112 for transmitting/receiving data and/or content to another device, e.g., a personal computer, a personal digital assistant (PDA), a server residing on the Internet, etc. Optionally, the media device 100 may include a microphone 114 for acquiring audio from the user of the device to input data.

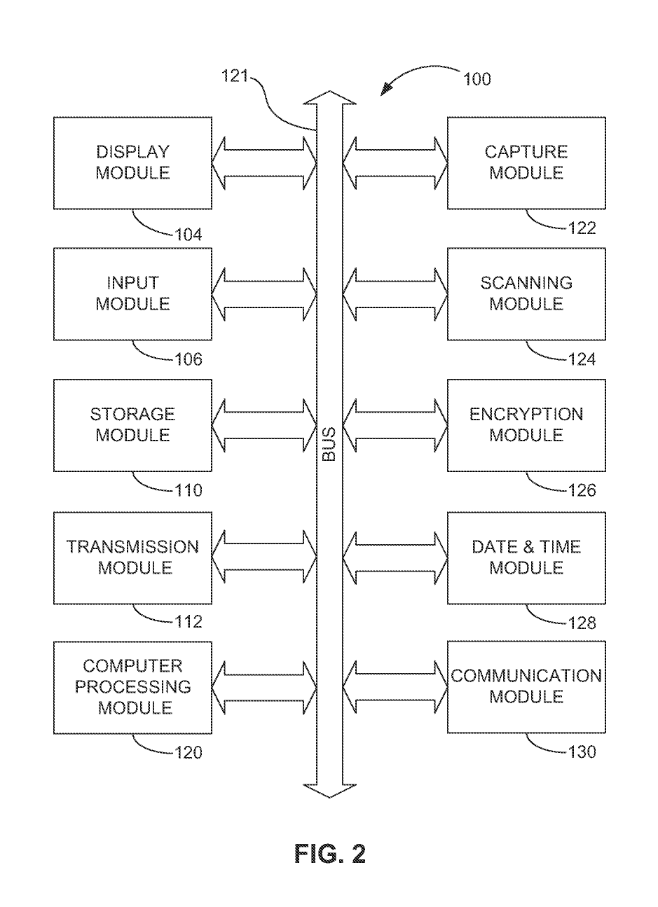

Referring to FIG. 2, various components of the mobile device 100 are described. The mobile device 100 contains a computer processing module 120, e.g., a microprocessor. The computer processing module 120 may use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 121 couples the various components shown in FIG. 2 and may be any of several types of bus structures including a memory bus or memory controller, a peripheral bus, and a local bus using any of a variety of bus architectures. The mobile device 100 also includes an operating system and micro instruction code preferably residing in read only memory (ROM) (not shown). The various processes and functions described herein may either be part of the micro instruction code or part of an application program (or a combination thereof) which is executed via the operating system. Exemplary operating systems include but are not limited to SymbianOS, Windows Mobile/Windows CE, Palm OS, iOS (Apple), Linux, Blackberry OS, BREW, etc., which have been developed for mobile computing applications and can handle both data computing and communication applications, e.g., voice communications.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer processing module 120 may further include, in addition to a microprocessor, a digital signal processor (DSP) for decoding stored audio, video and photo files to be played on the mobile device 100. As is known in the art, the DSP may include several known decompression algorithms for decompressing stored media content, e.g., a MP3 file. The device 100 of the present disclosure may support any of various file types including but not limited to Microsoft Windows Media Video files (.wmv), Microsoft Photo Story files (.asf), Microsoft Windows Media Audio files (.wma), MP3 audio files (.mp3), JPEG image files (.jpg, .jpeg, .jpe, .jfif), MPEG movie files (.mpeg, .mpg, .mpe, .m1v, .mp2v .mpeg2), Microsoft Recorded TV Show files (.dvr-ms), Microsoft Windows Video files (.avi) and Microsoft Windows Audio files (.wav).

The device 100 also contains a display module 104 for displaying digital information such as video files, image files, text files, etc. This display may be in any current form in the art, including Liquid Crystal Displays (LCD), Light Emitting Diode (LED) displays, Cathode Ray Tube (CRT) displays or any other type of display currently existing or existing in the future. The display module 104 may also include an audio output device, e.g., a speaker 116, audio port 118, etc., allowing the user to also hear audio output from the device 100, e.g., audio associated with a video, a MP3 file, etc.

The device 100 of the present disclosure may contain a user input module 106 to either receive user instructions via text input by the way of buttons 108, a standard keyboard interface coupled to the device, or a character recognition capture device which translates user text input into alphanumeric characters. In some embodiments, the character recognition device may include a touch screen which overlays the display module 104 such that text may be entered via a pen-like stylus or other instrument. Such input devices are standard and currently available on many electronic devices including portable digital assistants (PDAs) and cellular telephones. Optionally, microphone 114 may be further coupled to the input module 106 for capturing any audio information spoken by the user and the input module will further include an analog-to-digital (A/D) converter for converting the spoken audio information into a digital format. Furthermore, the input module may include a voice recognition processor that translates the digital human voice into alpha numeric characters for user input. The user may utilize the user input module 106 to enter various data, e.g., to initiate communication with a remote server, to request information from the server, etc.

The storage module 110 includes internal storage memory, e.g., random access memory (RAM), or removable memory such as magnetic storage memory; optical storage memory, e.g., the various known types of CD and DVD media; solid-state storage memory, e.g., a CompactFlash card, a Memory Stick, SmartMedia card, MultiMediaCard (MMC), SD (Secure Digital) memory; or any other memory storage that exists currently or will exist in the future.

The transmission module 112 will enable the device 100 to transmit or transfer information to other computing devices and to receive information from other computing devices, e.g., digital media files, codes to unlock downloaded media, encryption/decryption keys, etc. The transmission module 112 will perform its functionality by hardwired and/or wireless connectivity. The hardwire connection may include but is not limited to hard wire cabling, e.g., parallel or serial cables, USB cable, Firewire (1394 connectivity) cables, and the appropriate port. The wireless connection may operate under any of the various known wireless protocols including but not limited to Bluetooth™ interconnectivity, infrared connectivity, radio transmission connectivity including computer digital signal broadcasting and reception commonly referred to as Wi-Fi or 802.11.X (where x denotes the type of transmission), satellite transmission or any other type of communication protocols or systems currently existing or to be developed for wirelessly transmitting data. The transmission module 112 may compress and encode the encrypted information for transmission using any known wireless communication technology. In one embodiment, antenna ANT is coupled to the transmission module 112 for extending the wireless transmission range of the device 100.

A capture module 122 is provided to capture an image desired by the user in digital form, e.g., an image of an article of commerce, a barcode, etc. The capture module 122 may include an image sensor, an analog-to-digital (ND) converter and a digital signal processor (DSP). Referring to FIG. 1B when a user desires to capture an image, a lens 137 disposed on a rear side of the mobile device 100 is aimed at a subject of the image and is used in conjunction with display module 104 for positioning a subject of the image in lieu of a viewfinder. Light is allowed to enter through the lens 137 and shine on the image sensor, e.g., a charge-coupled device (CCD) or complimentary metal-oxide semiconductor (CMOS). The image sensor may include millions of photosensors, e.g., pixels, wherein each pixel absorbs the light and transforms the light into an electric charge proportional to the intensity of light. Each charge can be transmitted to an A/D converter where the charge is converted into a digital value representing the color the pixel will be, e.g., representing different intensities of red, green and blue. The digital values are then passed to the digital signal processor which may enhance the image, compress it, and then stores it in a digital file format in the storage module 110.

In other embodiments, the mobile device 100 further includes an integrated scanning module 124 for scanning a barcode or other symbology on an article of commerce. The scanning module 124 may contain a light source, e.g., LED, and photocell coupled to the computer processing module 120, or alternatively, may include a separate decoder engine that will decode the data received by the photocell before sending it to the computer processing module 120. Knowledge of the art reveals that many different types of scanners currently exist and the inventor realizes that the type of scanner would depend upon the type symbology that is utilized in the printed images. The symbology may be in any form currently practiced in the art, including barcodes (e.g., UPC, EAN, PDF417, etc.), photosymbols, standard or specialized text, etc., or any future type of symbology.

It is to be appreciated that the capture module 122 may also be used in conjunction with the scanning module 124 to read symbology associated with an article of commerce. Here, the capture module 122 may acquire an image of the symbology and the scanning module 124 may further include a digital signal processor executing an algorithm for deciphering or decoding the symbology from the captured image. The use of an image sensor to read symbology, e.g., a barcode, is known in the art and systems employing such technology, for example, are commercially available from Symbol Technologies of New York.

The mobile device 100 may also include an encryption module 126. The encryption module 126 may use conventional code encryption algorithms currently in use or that may be uses in the future such as symmetric-key algorithms, e.g., DES, Triple-DES, Blowfish, RC2, RC4, RC5, etc., and asymmetric-key algorithms, e.g., Diffie-Hellman, RSA, EIGamal, etc. to decrypt locked digital media content files that are stored in the storage module 110. The encryption module 126 may also encrypt payment information of a user before the payment information is transmitted to another device or server.

Furthermore, the mobile device 100 may also include a date and time module 128. The date and time module 128 uses standard computer chip processing technology widely in use, e.g., a crystal, or alternatively, input from a GPS receiver to supply the date and time.

In one embodiment, the device 100 according to the principles of the present disclosure is embodied as a mobile phone including the modules and architecture illustrated in FIG. 2. In this embodiment, microphone 106 is further coupled to a communication module 130 for encoding a user's speech to be transmitted via antenna ANT using CDMA, PCS, GSM or any other known wireless communication technology. The user will enter phone numbers to be dialed via the touch screen, or alternatively, as is known in the mobile phone art, the device 100 may include a full QWERTY keyboard as an input module to enter text information. In addition to producing audio from audio or multimedia content, speaker 116 will be coupled to the antenna ANT and a decoder for receiving and decoding voice communication from another mobile phone.

It is to be appreciated that the communication module 130 may include a single integrated circuit chip to perform data transfer and voice communications or a single module including a separate data transfer chip, e.g., a WiFi transceiver, and a separate voice communication chip, e.g., a CDMA chip. In one embodiment, the communication module will operate on the wireless GPRS (General Packet Radio Service) data protocol or a 3G or 4G protocol such as W-CDMA, CDMA2000 and TD-SCDMA. The GPRS, 3G, and 4G protocols have the ability to carry both voice and data over the same service.

It is to be appreciated that the device 100 described above is an exemplary device and may include all or a portion of the modules described above. Furthermore, it is to be appreciated that existing mobile devices, e.g., mobile phones, digital media playback device, may be used in accordance with the principles of the system and method of the present disclosure described below.

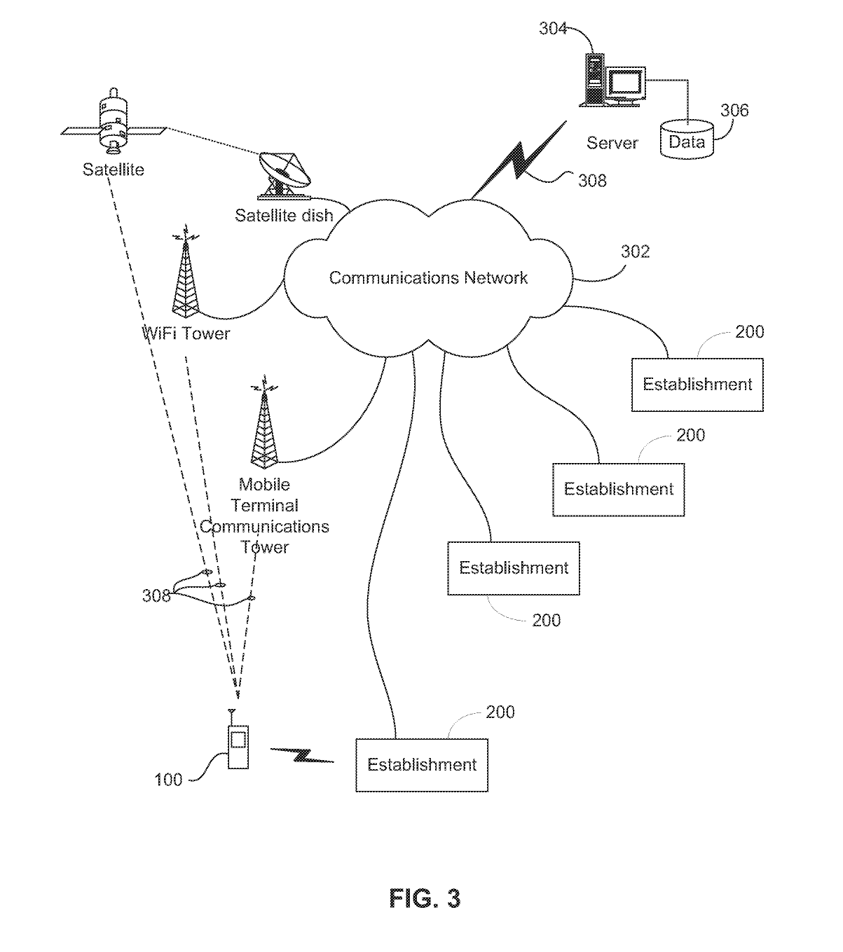

Systems and methods are provided herein for temporarily lending digital media content and enabling the purchase of the content if desired, which is described below in relation to FIGS. 3-11. Referring to FIG. 3, a system in accordance with the present disclosure is illustrated. The system includes a mobile device 100 as described above. The mobile device 100 may be configured to communicate with a server 304 via a communication network 302.

The device 100 and server 304 may be connected to the communications network 302, e.g., the Internet, by any known means, for example, a hardwired or wireless connection 308, such as dial-up, hardwired, cable, DSL, satellite, cellular, PCS, wireless transmission (e.g., 802.11a/b/g), etc. It is to be appreciated that the network 302 may be a local area network (LAN), wide area network (WAN), the Internet or any known network that couples a plurality of computers to enable various modes of communication via network messages. Furthermore, the server 304 may communicate using the various known protocols such as Transmission Control Protocol/Internet Protocol (TCP/IP), File Transfer Protocol (FTP), Hypertext Transfer Protocol (HTTP), etc., and secure protocols such as Internet Protocol Security Protocol (IPSec), Point-to-Point Tunneling Protocol (PPTP), Secure Sockets Layer (SSL) Protocol, etc.

The server 304 further includes a storage medium 306 for storing a database, which includes, among other things, one or more purchasable digital works. The digital works may include songs, videos, movies, electronic books, or other types of digital media content. The digital media content may be downloaded to the mobile device 100 either directly or indirectly through one of multiple establishments 200. For example, each establishment 200 may represent a brick and mortar building where customer may shop. The establishments 200 may represent a physical presence where customer can be met face-to-face, as opposed to online businesses that may interact with customers from any location. The establishments 200 may include coffee shops, retail stores, shopping malls, or other facilities. While the mobile device 100 is located within the premises of the establishment 200, digital media content may be loaned out to the user of the mobile device 100 for temporary use. When the user leaves the premises of the establishment 200, the user no longer is allowed to receive free access to the digital media content, unless the user purchases and downloads the content to the mobile device 100.

The mobile device 100 uses communication protocols including but not limited to Wi-Fi (a, b, c d, n, x), mobile phone communications such as GSM, CDMA, FOMA, etc., infrared communications, cabled communications, Bluetooth communications, and satellite communications. The mobile device 100 may request to receive temporary access to the digital media content via the establishment 200 or to purchase the content either directly from the server 304 or via the establishment 200. In this respect, the server 304 represents the owner (e.g., artist, musician, author, copyright owner, distribution company, etc.) of the digital media content, and the establishment 200 acts as a distributor of the digital media content. It is to be appreciated that the mobile device 100 may use any one or a combination of protocols to transmit the request to the establishment 200 or server 304. For example, the mobile device 100 may employ a telecommunication protocol to transmit the request via the communication module 140.

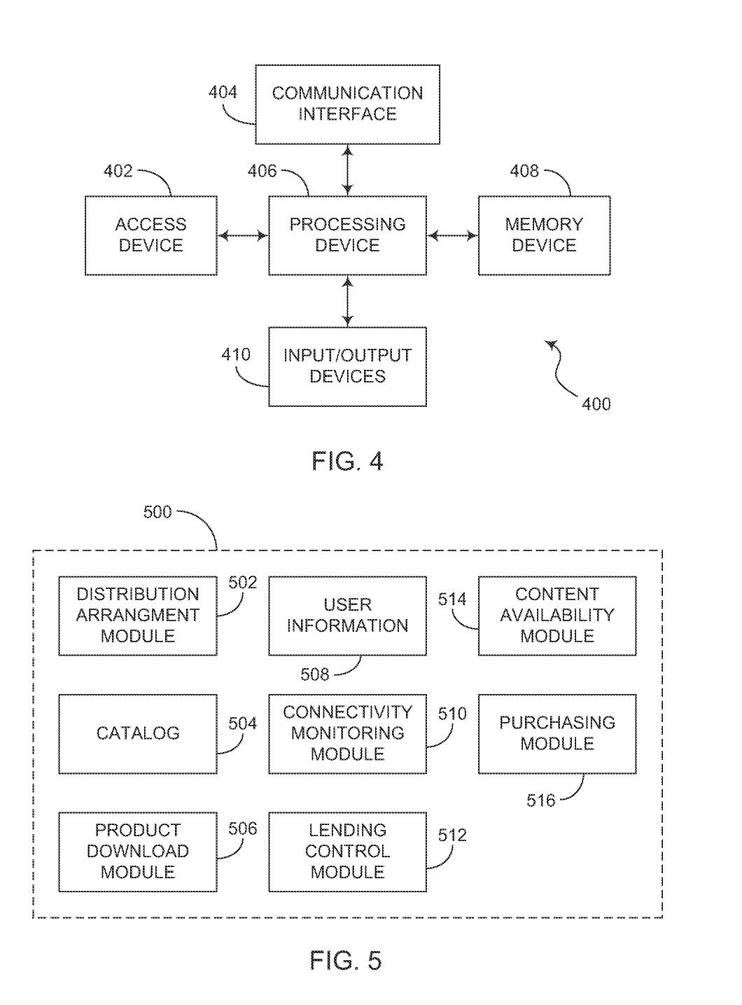

FIG. 4 shows a block diagram of a content lending management system 400, according to various embodiments. The content lending management system 400 may include features that are a part of the computer systems of each establishment 200. In some embodiments, some or all of the features of the content lending management system 400 may be incorporated in the server 304 and respective database 306. As illustrated in this embodiment, the content lending management system 400 includes an access device 402, a communication interface 404, a processing device 406, a memory device 408, and input/output devices 410.

The access device 402 allows users to temporarily access the content lending management system 400 or a local area network (LAN) associated with the system 400. For example, the access device 402 may be a wireless access point (WAP) device for enabling Wi-Fi or other wireless communication to link a number of mobile devices 100 in the vicinity of the access device 402 to the system 400. In some embodiments, the access device 402 may be a wired connection for connecting the mobile devices 100 to the system 400, perhaps using USB connections. The communication interface 404 allows the content lending management system 400, when located at an establishment 200, to communicate with the server 304 via the communications network 302.

The processing device 406 may be any suitable type of processor or microprocessor for executing instructions stored in software, hardware, and/or firmware in the content lending management system 400. The memory device 408 may include software instructions for enabling the content lending management system 400 to manage an arrangement with an owner of digital media content and control agreed-upon lending of the digital media content to nearby mobile devices 100 on a temporary basis. The details of a content lending program are described below. In addition, the memory device 408 may be configured to store digital media content either in temporary storage or long term storage. For example, portions of samples of content may be stored in the memory device 408 and even entire works of digital media content may be stored in the memory device 408 as well. When stored in long term storage, the content in the memory device 408 may be distributed to customers in a temporary arrangement.

The content lending management system 400 may also include input/output devices 410. The input/output devices 410 may include keyboards, touchscreens, etc., for allowing a user to input information and display screens or other audible or visual output devices for communicating information to the user. For example, a customer in a respective establishment 200 may wish to communication with the staff at the establishment, such as to place an order for food or beverage, to ask a question, or for other reasons.

FIG. 5 is a diagram illustrating a content lending program 500 according to various embodiments of the present disclosure. The content lending program 500 may be software stored in the memory device 408 and executable by the processing device 406 or other instruction executing device. According to various implementations, the content lending program 500 may be software, firmware, and/or hardware of the content lending management system 400. The content lending program 500, as shown in FIG. 5, includes a distribution arrangement module 502, a catalog 504, a product download module 506, user information 508, a connectivity monitoring module 510, a lending control module 512, a content availability module 514, and a purchasing module 516.

The distribution arrangement module 502 allows an establishment (e.g., one of the establishments 200 of FIG. 3) to make an arrangement with an owner (e.g., via server 304) of digital media content. The distribution arrangement module 502 allows the establishment to download digital media content either free of charge or at a reduced price, with the understanding that the content may be temporarily distributed to patrons of the establishment while on the premises of the establishment. The arrangement between the establishment and the owner's server may also include an agreement that a commission would be paid to the establishment when the content is purchased by a customer. The distribution arrangement module 502 may comprise a contract of the agreement between the establishment and the owner regarding various terms for the distribution of the digital media content.

The catalog 504 of the content lending program 500 may include samples of digital media content or one or more entire works of certain content. In some cases, the catalog 504 may simply list a certain number of the most popular or most frequently requested content available.

The product download module 506 is configured to enable the establishment to download digital media content from the owner, under the terms of the pre-established agreements. The content may be downloaded in its entirety or in small portions over a certain time period. The downloaded content may, according to some implementations, be stored in temporary storage to ensure that the content is not distributed in a way that may violate any agreements, arrangement, and/or copyright infringement.

The user information 508 includes information of users who have registered with a particular establishment, thereby allowing them to utilize the temporary lending process. Each establishment may gather any necessary information from the users according to their own policies. Some of this information may be stored for determining the various interests of the user, such that the catalog 504 presented to a user may be created in a custom format according to likes and dislikes.

In some embodiments, the user information 508 may also include virtual bookmarks. According to the present disclosure, a virtual bookmark is a location somewhere in the middle of a digital work. For example, a user in a certain establishment may be in the process of reading a book in electronic form, which has been temporarily downloaded or streamed to the user's mobile device. While in the middle of digital work, connection between the mobile device 100 and the access device 402 may be terminated for whatever reason. For example, access termination may be a result of the mobile device 100 being moved outside the range of a Wi-Fi hotspot or outside the premises of the establishment. In any case, the user may leave the establishment hoping to return in order to continue reading. By the establishment storing a record of the virtual bookmark, where the user left off, and storing this virtual bookmark with the user information 508, the user may be able to pick up from where they left off. In another embodiment, the virtual bookmark may be stored in the user device 100.

The content lending program 500 also includes a connectivity monitoring module 510 as shown in FIG. 5. The connectivity monitoring module 510 detects whether or not a connection is being maintained between the mobile devices of the various users and the content distribution management system 400 (FIG. 4) via the access device 402. When the connectivity monitoring module 510 detects that the connection is broken, the program 500 may place a virtual bookmark with the user information 508 to indicate where a user left off.

According to some embodiments, the connectivity monitoring module 510 may operate in conjunction with the access device 402 to control whether or not the user is allowed to be connected. For example, if the user's device contains a global positioning system (GPS) device, the user may be allowed access only if the mobile device is within the confines of the establishment. When the user's mobile device is taken outside of the premises, a GPS tracking device may detect that the user is no longer in the establishment and therefore may terminate the connection.

The lending control module 512 may be configured to control the supply of digital media content to the various mobile devices. The content that is downloaded by the product download module 506 is distributed to the mobile devices according to an arrangement with the mobile devices such that the content cannot be stored for unrestricted use, unless the content is actually purchased. The lending control module 512 may continually supply or stream the content to the mobile device. Alternatively, the lending control module 512 may periodically transmit one or more blocks of data at a time. In some embodiments, the lending control module 512 may use encoded transmission for control the lending of content in a secure manner.

The content availability module 514 may be configured to determine any digital media content that has already been stored in the memory device 408. For example, if a user wishes to read an electronic book that has already been downloaded and stored in memory, the content availability module 514 may search the files of the memory device 408 as needed. If the content is not readily available from the memory device 408, the content availability module 514 may communicate with the product download module 506 to initiate a download process.

After having an opportunity to sample portions of a digital work, a user may wish to purchase the work. In this case, the purchasing module 516 is configured to receive a purchase request and further receive payment information from the user. If necessary, the entire digital work may be download from the server 304 (e.g., if only a portion had previously been downloaded). The purchased digital work can then be enjoyed by the user in an unrestricted manner, regardless of the location of the user. According to the arrangement with the owner, the purchasing module 516 may keep a portion of the payment (e.g., a commission) for the purchased content and submit the remaining amount to the owner.

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine, comprising any suitable architecture such as a personal computer, a workstation or server. Preferably, the machine is implemented on a computer platform having hardware such as one or more central processing units (CPU), a random access memory (RAM), a read only memory (ROM) and input/output (I/O) interface(s) such as a keyboard, cursor control device (e.g., a mouse or joystick) and display device. A system bus couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform of the machine by various interfaces and bus structures, such a parallel port, serial port or universal serial bus (USB). One such peripheral device may include a communications device, e.g., a modem, satellite relay, wireless connection, etc., for enabling communications to various servers. Other peripheral devices may include additional storage devices, a printer and a scanner.

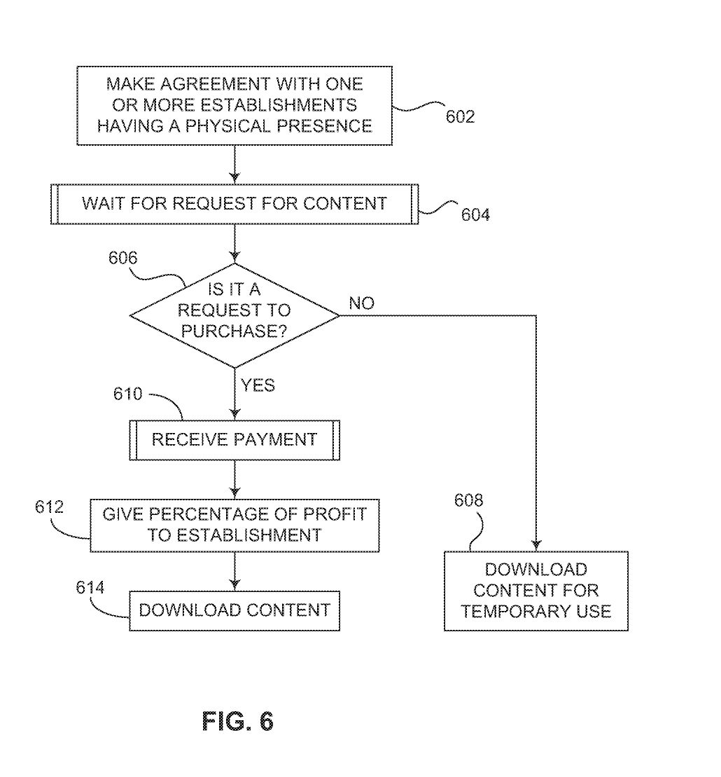

The operation of the system of FIG. 3, and particularly the operation of the content lending management system 400 of FIG. 4 and the content lending program 500 of FIG. 5, is described below with respect to FIGS. 6-11.

FIG. 6 is a flow diagram illustrating an embodiment of a method performed by systems associated with an owner of digital media content. As shown in this embodiment, the method comprises, as in block 602, making an agreement with one or more establishments, wherein the establishments may be businesses having a physical presence where staff working at the establishment can meet customers face-to-face. The agreement suggested in block 602 may include any negotiated terms with the establishments for distributing the owner's digital works or digital media content. As indicated in block 604, the method includes waiting for a request for content. For example, after the agreement is reached with the establishment, a patron of the establishment may request to temporarily access the owner's digital media content. In some embodiments, various works may already have been downloaded to the one or more establishments and a request is not necessarily submitted to the owner's systems.

As indicated in decision block 606, it is determined whether or not the request is a request to purchase the content. If not, the method proceeds to block 608 and the content is downloaded to the establishment for temporary use by the customer at the establishment. The content may be marked or encrypted in a way that is different from content that is being purchased. The specially marked content only allows temporary, not unrestricted, usage of the content.

If it is determined in decision block 606 that the request content is a request to purchase, the method proceeds to block 610. According to block 610, the owner waits to receive payment for the purchased digital work. In block 612, it is indicated that a certain percentage of the profit on the sale of the digital media content is given to the establishment. This may represent a cut for the establishment based on distribution services. When payment is received by the respective parties, the method finally includes downloading the digital media content to the user, either by way of the establishment or directly to the user. Having purchased the digital media content, the user may then play the content at any time without restrictions of position with respect to an establishment.

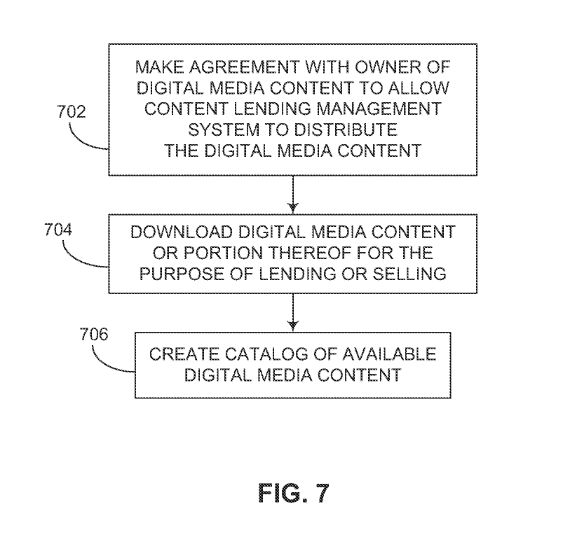

FIGS. 7-11 represent embodiments of methods that may be performed by the content lending management system 400 or other device or system for lending digital media content. In FIG. 7, a method is provided that enables an establishment to set up a process for enabling the lending of digital content. First, an agreement is reached with one or more owners of various digital works that contain digital media content, as indicated in block 702. The agreement allows the content lending management system to distribute the digital media content. Arrangements may be made with multiple owners under different agreements, if desired. This agreement described in block 702 may be the same or similar agreement described with respect to block 602, except from the perspective of the content lending management system.

Once an agreement is made, the establishment may download digital media content or a portion thereof from the respective owners, as indicated in block 704. The content is downloaded, not for unlimited use by the establishment, but for the purpose of lending the content to customers at the establishment or for selling to these customers. As indicated in block 706, a catalog may be created of available digital media content. In this respect, the catalog may be presented to the customers upon request or when the customers first enter the establishment.

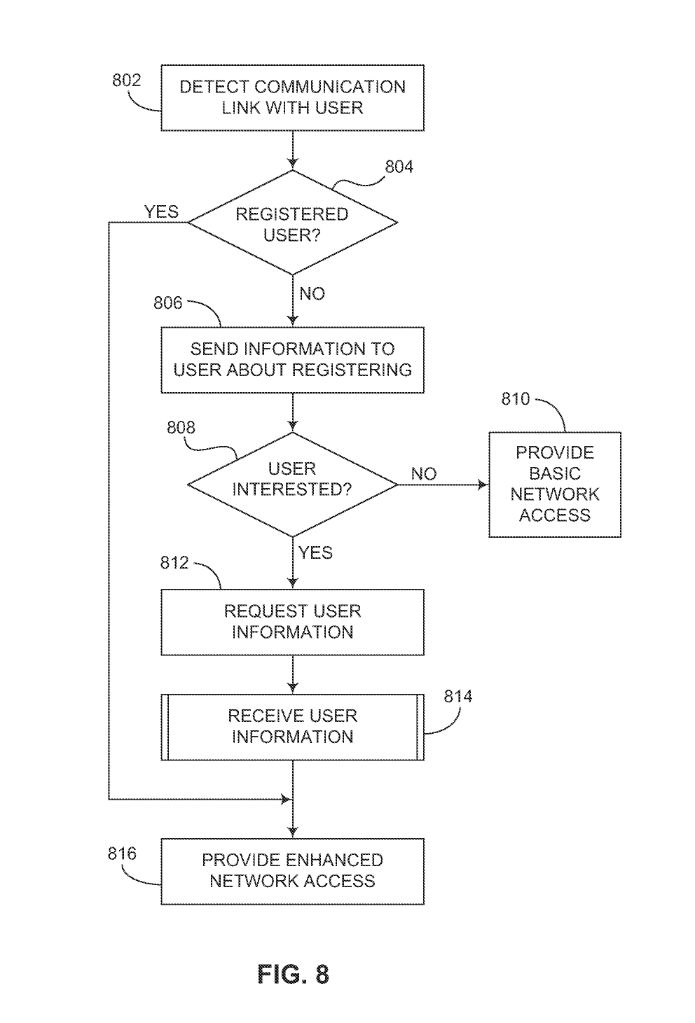

FIG. 8 is a flow diagram illustrating an embodiment of a method to be performed when a customer first accesses the content lending management system. As indicated in block 802, the method includes detecting a communication link with a user. For example, the communication link may be detected by the connectivity monitoring module 510 to determine when a new user enters the establishment and gains access to the content lending management system 400 via the access device 402.

According to decision block 804, it is determined whether or not the new user is a registered user. If so, the method skips ahead to block 816. Otherwise, if the user is not registered, the method proceeds to block 806, which indicates that information is sent to the user about how to register with the content lending management system. In decision block 808, a response from the user is received to determine if the user is interested in registering. If not interested, the method goes to block 810 and the user may be given access to the basic network functions (e.g., regular Internet access). If the user does wish to register, however, the method proceeds to block 812.

In block 812, the system requests that the user provide certain information. In block 814, the user information is received and stored in memory for later processing. When the user is registered, the method provides an enhanced network access, as indicated in block 816. In this respect, the enhanced access allows the user to request and receive free access to the digital media content on a temporary basis (i.e., while the user is on the premises of the establishment).

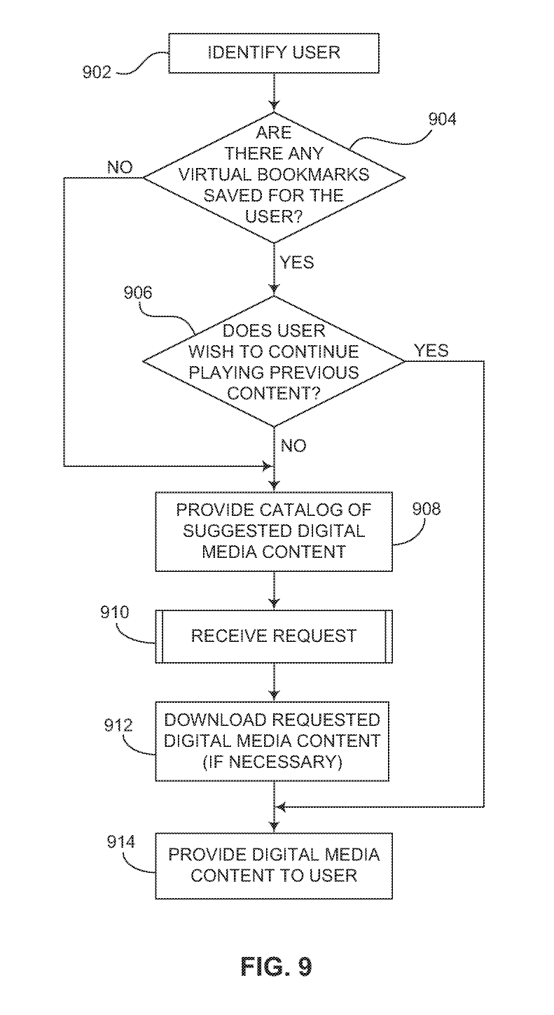

FIG. 9 is a flow diagram illustrating an embodiment of a method for communicating with a customer. As indicated in block 902, a user is identified based on an identification of the mobile device, based on user name and password information, or based on other identification processes. As in block 904, it is determined whether or not there are any virtual bookmarks saved for the user. A virtual bookmark is used to mark a place, or location in the digital media content, e.g., a page number, where a user may have left off during a previous visit to the establishment. If there are no saved virtual bookmarks for this user, the method skips to block 908. Otherwise, if a bookmark is available, it can be presented to the user. In decision block 906, it is indicated that the method determines if the user wishes to continue playing the previous content, such as at or shortly before the place where the user left off. If the user wants to continue from the bookmark, the method jumps to block 914. Otherwise, the method proceeds to block 908, which indicates that a catalog is provided to the user of suggestions of digital media content. The user may be able to browse through this catalog list or other lists to determine what content he or she may wish to access. The method then includes receiving a request (block 910) for a particular digital work. As indicated in block 912, the requested digital media content is downloaded from the content owner's server (if necessary). If the content is already stored locally in the memory devices of the establishment, the content may be retrieved from memory at this point. As indicated in block 914, the digital media content is provided to the user. In some embodiments, the content may be streamed to the user's mobile device.

In a further embodiment, the virtual bookmark may be stored in the user or mobile device 100. In this embodiment, after the user or mobile device is identified, the virtual bookmark is either transmitted by the mobile device to the content lending system or is retrieved by the content lending system. Once the virtual bookmark is determined, the process proceeds as above.

At anytime after the digital media content is provided to the user device, the user will have the option to purchase the digital media content. In one embodiment, the purchase transaction will take place with the content lending management system. In another embodiment, the user is directed to a third party for payment who authorizes the download/continued use of the digital media content and provides payments to other parties, e.g., the content author.

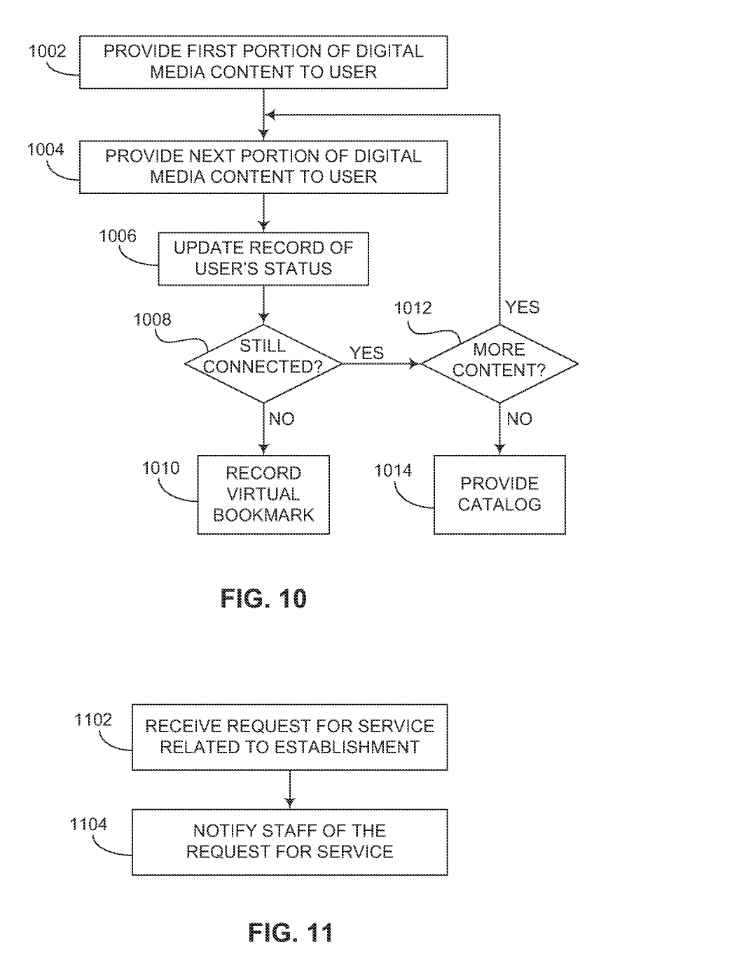

FIG. 10 is a flow diagram illustrating an embodiment of a method of providing digital media content to a user's device. As indicated in block 1002, the method includes providing a first portion of the digital media content to the user. In block 1004, a next portion of the content is provided to the user. As indicated in block 1006, records of the user's status are updated. For example, based on the portions that have already been provided to the user according to block 1002 and 1004, a record of this progress through the digital work can be recorded. If the user is reading an electronic book, for instance, a page number or chapter number at which the user is proceeding through the book may be recorded.

As indicated in decision block 1008, it is determined whether or not the user is still connected with the access device. If not, the method proceeds to block 1010, which indicates that a virtual bookmark is recorded indicating where the user left off. The virtual bookmark may indicate a page number or chapter of an electronic book, a particular song of an album, a time stamp or chapter number in a video or movie, or other marking indicator. In one embodiment, if the user is not online connected, the digital media content is not usable or accessible. At this point, the user has the option to delete the downloaded digital media content if desired.

If it is determined in block 1008 that the user is still connected, the method goes to decision block 1012, which determines whether more content is to be provided to the user or if the end of the content has been reached. If there is more content, the method loops back to block 1004 and a next portion of the content is provided. If no more content is available, the method goes to block 1014, which indicates that a catalog of other digital media content is provided to the user. The process of block 1014 may be similar to block 908 as described above.

FIG. 11 is a flow diagram illustrating a method according to additional embodiments for allowing communication with the user. In this embodiment, the method includes receiving a request from the user for a service that is related to regular services offered by the establishment. The request may take the form of a text message, an e-mail, a push message or any other known or to be developed communication means. The services as mentioned herein may refer to services other than the service of lending digital media content. For example, services in a restaurant may include ordering food or beverage, asking for the check, asking a question about the food, etc. Services in a coffee shop may include ordering a cup of coffee or a dessert, etc. In response to receiving the request for the service, the method includes notifying the staff at the establishment of the requested service, as indicated in block 1104. For example, if the customer requests to see a menu, an indication may be provided to the staff to indicate a table number and the specific request, in order that a staff member may attempt to honor the request.

According to embodiments of the present disclosure, a system for lending digital media content has been provided. The system comprises a mobile device having a user interface configured to output at least one of audio signals and video signals to a user of the mobile device. Also provided is a server configured to store digital media content and configured to download the digital media content upon request. The system also includes a content lending management system associated with an establishment, the establishment having a physical presence for meeting customers face-to-face. The content lending management system is configured to communicate with the mobile device and server. The content lending management system is further configured to receive a loan request from the mobile device and, in response to the loan request, provide the digital media content to the mobile device for temporary use.

Additionally, the content lending management system is configured to download the digital media content from the server prior to receiving the loan request. Alternatively, the content lending management system may be configured to download the digital media content from the server after receiving the loan request.

In some embodiments, the content lending management system is further configured to provide the digital media content to the mobile device when the user is on the premises of the establishment. The content lending management system may be further configured to discontinue the digital media content being provided to the mobile device when it is determined that the mobile device is no longer on the premises of the establishment or when communication between the mobile device and content lending management system is terminated. The content lending management system is further configured to record a virtual bookmark representing a place in the digital media content where providing the digital media content was discontinued. The content lending management system is further configured to allow the user to continue receiving the digital media content from the place represented by the virtual bookmark.

The content lending management system is further configured to receive an indication from the mobile device that the user wishes to purchase the digital media content and to download the digital media content to the mobile device for unrestricted use. In this respect, the content lending management system is configured to receive a portion of the profits from the purchase of the digital media content.

According to various implementations, the content lending management system may be further configured to create a catalog of available digital works for temporary use and to provide the catalog to the mobile device. The mobile device may communicate with the content lending management system by way of Wi-Fi access. Alternatively, the content lending management system may communicate with the server by way of a wired communication network. In some embodiments, the content lending management system enables the user to register with the establishment for the opportunity to receive temporary loans of the digital media content. In one embodiment, the content lending management system is further configured to receive a request from the mobile device for a face-to-face service provided by the establishment.

According to some embodiments, the present disclosure further describes an establishment having a physical presence. The establishment comprises an access device allowing a user device to access a local area network (LAN) associated with the establishment, a processing device configured to execute instructions regarding the lending of digital media content, and a memory device comprising at least a content lending program. The content lending program enables the lending of digital media content to the user device via the access device. The lending of the digital media content allows temporary use of the digital media content when the user device is on the premises of the establishment.

The content lending program may comprise connectivity monitoring module configured to determine whether or not a connection with the user device is maintained. The content lending program may also comprise a lending control module configured to terminate the lending of the digital media content to the user device when the user device is no longer on the premises of the establishment.

Furthermore, the present disclosure describes a method of a server that represents an owner of digital media content. The method comprises making an agreement with at least one establishment having a physical presence where customers are met. The method also includes downloading the digital media content for use on a temporary basis to a first establishment of the at least one establishment when a loan request is received from the first establishment. The method also includes downloading the digital media content for unrestricted use to a second establishment of the at least one establishment when a request for purchase and payment are received from the second establishment. Downloading the digital media content for use on a temporary basis includes downloading the content according to the agreement with the first establishment. The method may also include giving a percentage of a profit from a sale of the digital media content to the second establishment.

According to some embodiments, the present disclosure provides that the establishment acts as a distribution node for content provider. By default, the establishment can “lend” content to a user but that content cannot be accessed unless the user is in contact (i.e., online connected) with the node. Then the user can purchase the content at any time during the process (e.g., a “buy now” button is displayed in an interface on the user's device). Another “do you wish to purchase this content now” prompt can be provided when the mobile user device is no longer connected to the node (or after certain period of time). If so, the user can connect to the content provider directly (if not still in contact with the establishment) via another wireless connection.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A content lending management system for lending digital media content comprising:
an access device allowing a user device to access a node associated with an establishment;
a processing device configured to execute instructions regarding the lending of digital media content;
a memory device comprising at least a content lending program, the content lending program enabling the lending of digital media content to the user device via the access device;
wherein the lending of the digital media content allows temporary use of the digital media content when the user device is on the premises of the establishment and the content lending program is further configured to record a virtual bookmark representing a user location in the digital media content indicating where the digital media content was discontinued.

2. The system of claim 1, further comprising a communication interface configured to download the digital media content from a content server prior to receiving a loan request from the user device.

3. The system of claim 1, further comprising a communication interface configured to download the digital media content from a content server after receiving a loan request from the user device.

4. The system of claim 3, wherein the content lending program is further configured to discontinue the digital media content being provided to the user device when it is determined that the user device is no longer on the premises of the establishment or when communication between the user device and access device is terminated.

5. The system of claim 4, wherein the virtual bookmark is stored in a memory of the user device when communication between the user device and access device is terminated.

6. The system of claim 5, wherein content lending program is further configured to allow the user to continue receiving the digital media content from the user location in the digital media content represented by the virtual bookmark.

7. The system of claim 1, wherein content lending program is further configured to receive an indication from the user device that the user wishes to purchase the digital media content and to download the digital media content to the user device for unrestricted use.

8. The system of claim 7, wherein the content lending program is further configured to receive a portion of the profits from the purchase of the digital media content.

9. The system of claim 1, wherein the content lending program is further configured to create a catalog of available digital works for temporary use and to provide the catalog to the mobile device.

10. The system of claim 1, wherein the user device communicates with the access device by way of Wi-Fi access.

11. The system of claim 1, wherein the content lending program enables the user to register with the establishment for the opportunity to receive temporary loans of the digital media content.

12. The system of claim 1, wherein the content lending program is further configured to receive a request from the user device for a face-to-face service provided by the establishment.

13. The system of claim 12, wherein the request is at least one of a text message, an e-mail or a push message.

14. The system of claim 1, wherein the content lending program comprises connectivity monitoring module configured to determine whether or not a connection with the user device is maintained.

15. A method for lending digital media content within a particular location comprising:
identifying a user device within a particular location;
providing a catalog of suggested digital media content to the identified user device;
receiving a request from the user device for a selected one of the suggested digital media content;
providing the requested digital media content to the user device while the user device is within the particular location; and
recording a virtual bookmark representing a user location in the digital media content indicating where the digital media content was discontinued.

16. The method of claim 15, further comprising discontinuing the digital media content being provided to the user device when it is determined that the user device is no longer within the particular location.

17. The method of claim 15, further comprising storing the virtual bookmark in a memory of the user device when the user device is no longer within the particular location.

18. The method of claim 17, further comprising allowing the user to continue receiving the digital media content from the user location in the digital media content represented by the virtual bookmark.

20. The method of claim 15, further comprising receiving an indication from the user device that the user wishes to purchase the digital media content and to download the digital media content to the user device for unrestricted use.

21. A program storage device readable by a machine, tangibly embodying a program of instructions executable by the machine to perform method steps for lending digital media content, the method comprising:
identifying a user device within a particular location;
providing a catalog of suggested digital media content to the identified user device;
receiving a request from the user device for a selected one of the suggested digital media content; providing the requested digital media content to the user device while the user device is within the particular location; and
recording a virtual bookmark representing a user location in the digital media content indicating where the digital media content was discontinued.
